(19) United States
(12) Patent Application Publication
(10) Pub. No.: US 2026/0139109 A1
(43) Pub. Date: May 21, 2026

(54) METHOD FOR PREPARING POLARIZING FILM, AND POLARIZING FILM AND POLARIZER OBTAINED THEREFROM

(71) Applicants: Xiamen Tianma Display Technology Co., Ltd., Xiamen (CN); Wuhan Tianma Microelectronics Co. Ltd., Wuhan (CN)

(72) Inventors: Lei WANG, Xiamen (CN); Guofeng ZHANG, Xiamen (CN)

(73) Assignees: Xiamen Tianma Display Technology Co., Ltd., Xiamen (CN); Wuhan Tianma Microelectronics Co. Ltd., Wuhan (CN)

(21) Appl. No.: 19/450,283

(22) Filed: Jan. 15, 2026

(30) Foreign Application Priority Data
Aug. 28, 2025 (CN) 202511220088.2

(51) Int. Cl. C08J 5/18; B29D 11/00; C08J 7/14; G02B 5/30

(52) U.S. Cl. CPC C08J 5/18; B29D 11/00644; C08J 7/14; G02B 5/305; G02B 5/3075; C08J 2329/04

(57) ABSTRACT

Provided are a method for preparing a polarizing film, and a polarizing film and a polarizer obtained therefrom. The preparation method includes: subjecting a polyvinyl alcohol (PVA)-based film to swelling, dyeing, crosslinking, and stretching, where a solution used in at least one of the steps of swelling, dyeing, crosslinking or stretching includes an organic aromatic boric acid. In the process of preparing the polarizing film, the introduction of the organic aromatic boric acid can inhibit the polyene reaction of the optical film, thereby enhancing the stability of the polarizing film. Meanwhile, the incorporation of the aromatic group from the organic aromatic boric acid can improve the stability of iodine molecules within the polarizing film, and increase the water resistance and the ultraviolet blocking capability of the polarizing film.

This application claims priority to Chinese Patent Application No. 202511220088.2 filed with the China National Intellectual Property Administration (CNIPA) on Aug. 28, 2025 and titled “METHOD FOR PREPARING POLARIZING FILM, AND POLARIZING FILM AND POLARIZER OBTAINED THEREFROM”, which is incorporated herein by reference in its entirety.

### TECHNICAL FIELD

The present disclosure belongs to the field of optical thin films and specifically relates to a method for preparing a polarizing film, and a polarizing film and a polarizer obtained therefrom.

### BACKGROUND

A polarizer is a key optical component in display devices that controls the polarization direction of light waves. The core function of the polarizer relies on the molecular orientation and dyeing treatment of a polyvinyl alcohol (PVA) film. In organic light-emitting diode (OLED) display technology, the role of the polarizer becomes even more critical: although OLEDs possess self-emissive characteristics, OLEDs still require polarizers to eliminate ambient light reflection interference, particularly in outdoor settings, thereby enhancing contrast and visibility.

### SUMMARY

In view of the deficiencies in the existing art, the present disclosure aims to provide a method for preparing a polarizing film, and a polarizing film and a polarizer obtained therefrom. To achieve the object, the present disclosure adopts the following technical solutions.

In a first aspect, the present disclosure provides a method for preparing a polarizing film. The preparation method includes: subjecting a PVA-based film to swelling, dyeing, crosslinking, and stretching, where the solution used in at least one of the steps of swelling, dyeing, crosslinking or stretching includes an organic aromatic boric acid.

In the present disclosure, by introducing an organic aromatic boric acid during the process of processing the polarizing film, the organic aromatic boric acid can undergo condensation polymerization with the hydroxyl groups present in the PVA, thereby inhibiting the polyene reaction of the PVA and enhancing the stability of the PVA. Meanwhile, the aromatic ring of the organic aromatic boric acid can complex with iodine, thereby increasing the stability of iodine molecules. Furthermore, since the aromatic ring possesses hydrophobicity and ultraviolet light absorption properties, the introduction of the organic aromatic boric acid into the preparation method can not only enhance the water resistance of the polarizing film but also impart the ultraviolet blocking capability to the polarizing film.

In a second aspect, the present application provides a polarizing film prepared by the preparation method described in the first aspect.

In a third aspect, the present disclosure provides a polarizer. The polarizer includes the polarizing film described in the second aspect.

Compared with the existing art, the present disclosure has the following beneficial effects.

In the present disclosure, in the process of preparing the polarizing film, the introduction of the organic aromatic boric acid can inhibit the polyene reaction of the optical film, thereby enhancing the stability of the polarizing film. Meanwhile, the incorporation of the aromatic group from the organic aromatic boric acid can improve the stability of iodine molecules within the polarizing film, and increase the water resistance and the ultraviolet blocking capability of the polarizing film.

### BRIEF DESCRIPTION OF DRAWINGS

FIG. 1 is a schematic diagram of the molecular structure of the product formed by the reaction of PVA and 2-functional boric acid according to the present disclosure;

FIG. 2 is a schematic diagram of the molecular structure of the product formed by the reaction of PVA and 3-functional boric acid according to the present disclosure;

FIG. 3 is a schematic diagram of the molecular structure of the product formed by the reaction of PVA and 4-functional boric acid according to the present disclosure;

FIG. 4 is a schematic diagram one of the structure of a polarizer according to some preferred embodiments of the present disclosure;

FIG. 5 is a schematic diagram two of the structure of a polarizer according to some preferred embodiments of the present disclosure;

where 1-first protective layer; 2-polarizing film; 3-second protective layer; 4-first pressure-sensitive adhesive layer; 5-release film layer; 6-hard coating layer; 7-phase difference film; 8-second pressure-sensitive adhesive layer;

FIG. 6 is an OM image of a device prepared in Comparative Example 1, observed using an ultra-depth-of-field microscope (Keyence VHX-700) at a magnification of 100 times;

FIG. 7 is an image of an FIB section of a moiety in which the device prepared in Comparative Example 1 underwent corrosion; and

FIG. 8 is a comparison diagram of transmittance curves of the polarizers provided by Example 1 and Comparative Example 1.

### DETAILED DESCRIPTION

Technical solutions of the present disclosure are further described below through specific examples. It is to be understood by those skilled in the art that the examples are only intended to facilitate understanding of the present disclosure and are not to be construed as limiting the present disclosure.

During the reliability performance (RA) test of medium-sized OLEDs, a higher test temperature is required. However, the polarizer included in the OLED is prone to a polyene reaction at high temperatures, thereby leading to discoloration. Furthermore, the stability of the crosslinking between PVA and boric acid is reduced under high humidity, and the stability of iodine molecules (I₃⁻ and I₅⁻) towards boric acid becomes insufficient. Meanwhile, since the polarizer lacks an ultraviolet blocking function, ultraviolet rays may easily damage the organic light-emitting layer, thereby resulting in reduced service lifetime. Therefore, the present disclosure provides a method for preparing a polarizing film, which can inhibit the polyene reaction of PVA within the polarizing film at high temperatures, impart ultraviolet blocking and water resistance properties to the polarizing film, and enhance the iodine-dyeing capability of the PVA.

A first object of the present disclosure is to provide a method for preparing a polarizing film. The preparation method includes: subjecting a PVA-based film to swelling, dyeing, crosslinking, and stretching, where the solution used in at least one of the steps of swelling, dyeing, crosslinking or stretching includes an organic aromatic boric acid, and preferably, at least a swelling solution used in the step of swelling includes an organic aromatic boric acid. The specific preparation method is as follows:

S1: A PVA-based film is placed in a swelling tank for swelling treatment. The swelling treatment can improve the stability and dyeing effect of the PVA-based film. Preferably, the swelling solution used in the swelling tank is an organic aromatic boric acid solution.

S2. Dyeing: The swollen PVA-based film is immersed in a dyeing tank containing a dyeing solution to dye.

S3. Stretching: After dyeing is completed, the PVA-based film may be cleaned in a cleaning tank first, and then stretched in a stretching tank.

Specific explanations are given below:

As for the PVA-based film, the PVA-based film in the present disclosure may be any PVA film layer capable of being processed to obtain a polarizing film. The PVA-based film may be of any thickness, for example, 5-250 μm, for example, 5 μm, 10 μm, 20 μm, 25 μm, 50 μm, 100 μm, 200 μm, 250 μm, etc.

As for swelling, swelling is a crucial pretreatment step in the preparation of a polarizing film. The PVA-based film is immersed in a specific swelling solution to cause the PVA to swell. As a result, the spacing between molecular chains is increased, and the internal structure is relaxed, thereby facilitating subsequent iodine ion adsorption, dyeing, and stretching orientation. The effectiveness of swelling directly influences the orientation degree of PVA molecular chains, dye adsorption capacity, and other factors. The present disclosure does not impose excessive limitations on the swelling process, and any method capable of achieving the swelling function can be applied herein. For illustrative purposes only, a specific method for swelling is exemplified below.

The cleaned PVA-based film is placed in a swelling tank containing an organic aromatic boric acid solution for swelling treatment. The swelling treatment can improve the stability and dyeing effect of the PVA-based film.

In the present disclosure, by introducing an organic aromatic boric acid during the swelling process, the organic aromatic boric acid can undergo condensation polymerization with the hydroxyl groups present in the PVA, thereby inhibiting the polyene reaction of the PVA and enhancing the stability of the PVA. Meanwhile, the aromatic ring of the organic aromatic boric acid can complex with iodine, thereby increasing the stability of iodine molecules. Furthermore, since the aromatic ring possesses hydrophobicity and ultraviolet light absorption properties, the introduction of the organic aromatic boric acid into the preparation method can not only enhance the water resistance of the polarizing film but also impart ultraviolet blocking capability to the polarizing film.

In some preferred embodiments, the concentration of the organic aromatic boric acid solution is 2-8 wt %, for example, 2 wt %, 3 wt %, 4 wt %, 5 wt %, 6 wt %, 7 wt %, 8 wt %, etc. During the process of swelling treatment, the organic aromatic boric acid can undergo a preliminary crosslinking reaction with the polyhydroxy structure of the polarizing film, thereby improving the structural stability of the polarizing film and enhancing the dyeing effect of the subsequent dyeing step.

In some preferred embodiments, the functionality of the organic aromatic boric acid is greater than or equal to 2, for example, 2, 3, 4, etc.

In the present disclosure, the boric acid group (—B(OH)₂) contained in the organic aromatic boric acid can undergo a condensation reaction with the hydroxyl groups (—OH) present in the PVA to form boric acid ester groups, thereby inhibiting the polyene reaction of the PVA and enhancing the stability of the PVA.

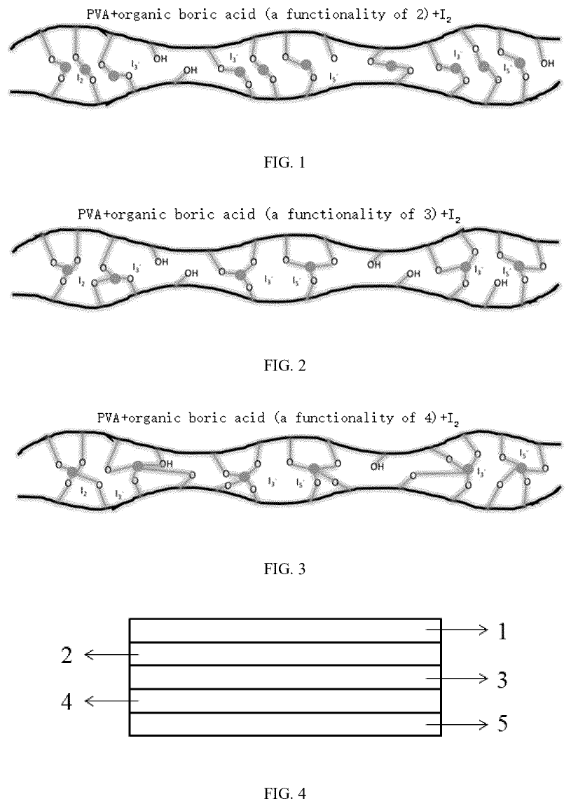

In the present disclosure, the schematic diagram of the molecular structure of the product formed by the reaction of the PVA and 2-functional boric acid is shown in FIG. 1, the schematic diagram of the molecular structure of the product formed by the reaction of the PVA and 3-functional boric acid is shown in FIG. 2, and the schematic diagram of the molecular structure of the product formed by the reaction of the PVA and 4-functional boric acid is shown in FIG. 4. As can be seen from the figures, the organic aromatic boric acid can undergo a reaction with the hydroxyl groups present in the PVA to form chemical bonds, thereby inhibiting the polyene reaction of the PVA and enhancing the stability of the PVA. Meanwhile, the aromatic ring of the organic aromatic boric acid can complex with iodine, thereby increasing the stability of iodine molecules. Furthermore, since the aromatic ring possesses hydrophobicity and ultraviolet light absorption properties, the introduction of the organic aromatic boric acid into the preparation method can not only enhance the water resistance of the polarizing film but also impart ultraviolet blocking capability to the polarizing film.

The present disclosure preferably adopts a multifunctional organic aromatic boric acid. The multifunctional organic aromatic boric acid can crosslink with the PVA to form hydrophobic microdomains, thereby increasing the hydrophobicity of the PVA. Moreover, through hyperconjugation between the organic aromatic ring and iodine molecules, the complexation and coordination ability with iodine molecules or ions is enhanced, thereby achieving an improvement in the water resistance and stability of (medium-sized) polarizers.

In some preferred embodiments, the organic aromatic boric acid is selected from at least one of the following compounds:

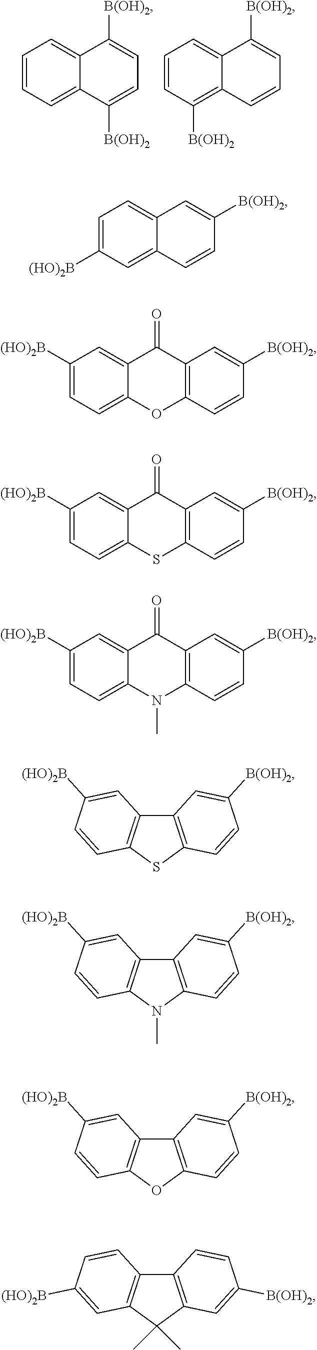

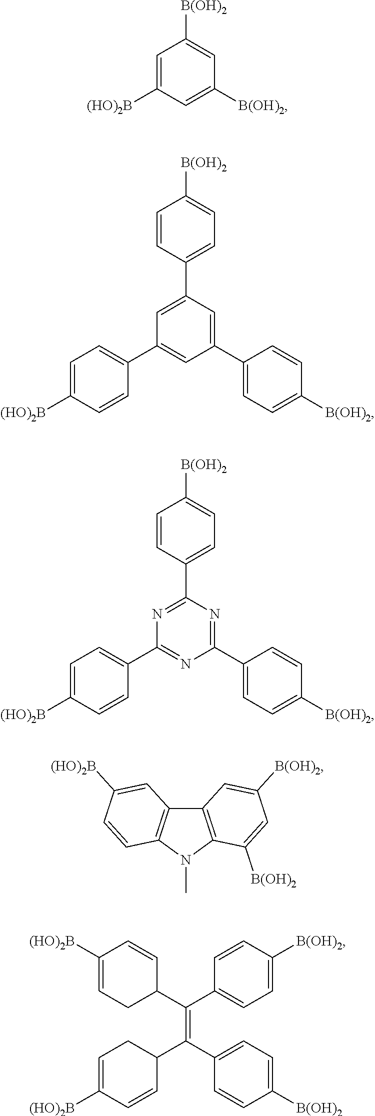 [SMILES: OB(O)c1cc(B(O)O)cc(B(O)O)c1 ; OB(O)c1ccc(-c2cc(-c3ccc(B(O)O)cc3)cc(-c3ccc(B(O)O)cc3)c2)cc1 ; OB(O)c1ccc(-c2nc(-c3ccc(B(O)O)cc3)nc(-c3ccc(B(O)O)cc3)n2)cc1 ; Cn1c2ccc(B(O)O)cc2c2cc(B(O)O)cc(B(O)O)c21 ; OB(O)C1=CCC(/C(=C(/c2ccc(B(O)O)cc2)C2C=CC(B(O)O)=CC2)c2ccc(B(O)O)cc2)C=C1]

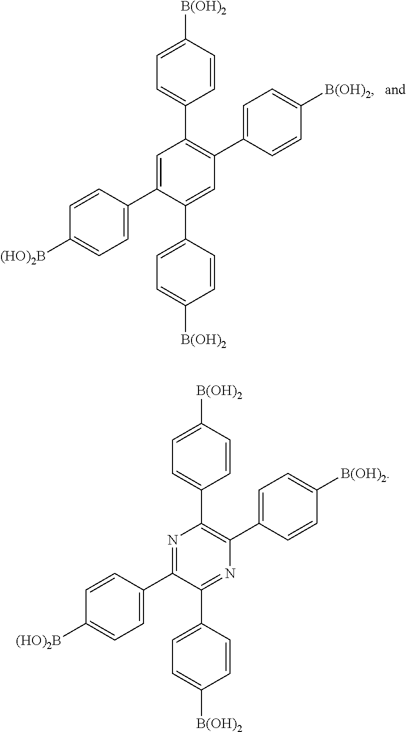 [SMILES: OB(O)c1ccc(-c2cc(-c3ccc(B(O)O)cc3)c(-c3ccc(B(O)O)cc3)cc2-c2ccc(B(O)O)cc2)cc1 ; "and" ; OB(O)c1ccc(-c2nc(-c3ccc(B(O)O)cc3)c(-c3ccc(B(O)O)cc3)nc2-c2ccc(B(O)O)cc2)cc1]

In some preferred embodiments, potassium iodide may also be added to the organic aromatic boric acid solution at a concentration of 0.1-0.5 wt %, for example, 0.1 wt %, 0.2 wt %, 0.3 wt %, 0.4 wt %, 0.5 wt %, etc. The addition of a small amount of potassium iodide during the swelling process can provide iodide ion reserve for the subsequent dyeing step, so that the PVA can initially adsorb a small amount of iodine in the swelling stage, thereby shortening the overall process time.

In some preferred embodiments, the temperature of swelling is 40-80° C., for example, 40° C., 45° C., 50° C., 55° C., 60° C., 80° C., etc. Swelling at 40-80° C. can accelerate the penetration of the swelling solution, but the temperature needs to be avoided exceeding the glass transition temperature of the PVA to prevent film deformation or dissolution.

In some preferred embodiments, the time of swelling is determined based on the thickness of the PVA-based film and the concentration of the swelling solution, and may be 1-5 minutes (min), for example, 1 min, 2 min, 3 min, 4 min, 5 min, etc., thereby ensuring that the PVA film is completely immersed and free of attached bubbles.

In some preferred embodiments, after the swelling is completed, the thickness of the PVA-based film increases to some extent, and the surface of the PVA-based film appears moist but shows no obvious signs of dissolution. Generally, the film thickness preferably increases by 20%-50%, for example, 20%, 25%, 30%, 35%, 40%, 45%, 50%, etc.

As for dyeing, the dyeing step is one of the core processes in polarizing film preparation and aims to allow the PVA-based film to selectively adsorb iodine molecules (or dichroic dyes) to form a dichroic material with a specific polarization direction. Through dyeing, the PVA molecular chains can align the iodine molecules directionally during subsequent stretching, thereby enabling the absorption and transmission of light in a specific polarization direction and imparting functional characteristics to the polarizing film.

In some preferred embodiments, the dyeing solution typically includes iodine. Iodine can enhance the contrast, transmittance, and polarization degree of the PVA film. During dyeing, hydroxyl groups on the PVA molecular chains form complexes with iodine molecules (I₃⁻ and I₅⁻). The formed complexes exhibit dichroism, and in subsequent stretching, the iodine molecules realign along the stretching direction to form a highly ordered polarizing structure. The uniformity of dyeing and the amount of iodine adsorption directly affect the polarization degree, transmittance, and durability of the polarizing film. The iodide ions included in the dyeing solution can maintain electrostatic balance, and can also promote the bonding between iodine molecules and the PVA.

In some preferred embodiments, the concentration of iodine molecules in the dyeing solution is 1-5 g/L, for example, 1 g/L, 2 g/L, 3 g/L, 4 g/L, 5 g/L, etc. Preferably, the concentration of potassium iodide is 10-20 g/L, for example, 10 g/L, 12 g/L, 14 g/L, 15 g/L, 16 g/L, 18 g/L, 20 g/L, etc.

In some preferred embodiments, the dyeing solution may also include a certain amount of boric acid and/or organic aromatic boric acid, preferably, organic aromatic boric acid. The introduction of organic aromatic boric acid during dyeing can regulate the pH of the dyeing solution to inhibit PVA hydrolysis, and can also stabilize iodine molecules.

In some preferred embodiments, the temperature of the dyeing solution is typically 20-60° C., for example, 20° C., 25° C., 30° C., 35° C., 40° C., 45° C., 50° C., 55° C., 60° C., etc., preferably, 30-40° C. The time of immersing is typically 30-120 seconds(s), for example, 30 s, 40 s, 50 s, 60 s, 70 s, 80 s, 90 s, 100 s, 110 s, 120 s, etc.

In some preferred embodiments, in the present disclosure, before stretching, washing (crosslinking) may first be carried out. Preferably, the washing method involves placing the PVA-based film in a washing tank. The residues in the PVA-based film can be removed through washing, and the degree of crosslinking of PVA molecules can also be regulated, thereby optimizing the polarizing performance, durability, and mechanical strength of the polarizing film.

In some preferred embodiments, the washing may be carried out using only high-purity deionized water to remove iodine, potassium iodide, or other residues from the dyeing solution. After washing, a crosslinking system solution may be introduced. The crosslinking system solution may include boric acid and/or organic aromatic boric acid, preferably organic aromatic boric acid. The crosslinking system solution can form boric acid ester bonds between PVA molecular chains to enhance the hydrogen bonding network. The present disclosure does not impose excessive limitations on the washing method, and any method that meets the requirements of washing may be applied herein.

Stretching refers to physically extending the PVA film to highly orient the PVA molecular chains in a specific direction and promote the ordered arrangement of iodine molecules between the molecular chains, thereby forming a polarizing structure with significant dichroism. In the present disclosure, the washed PVA film is immediately immersed in a stretching tank for stretching. The stretching solution used in the stretching tank may include organic aromatic boric acid. In the present disclosure, a portion of organic aromatic boric acid may be reintroduced during stretching to enhance the stability of PVA.

In some preferred embodiments, the stretching ratio is 3 to 6 times the length of the PVA-based film, for example, 3 times, 3.5 times, 4 times, 4.5 times, 5 times, 5.5 times, 6 times, etc.

In the present disclosure, high-ratio stretching is preferably adopted to improve the orientation of macromolecules and polyiodine substances, thereby enabling the complexes to be aligned in the same direction and generating polarizing properties.

In some preferred embodiments, the temperature of stretching is 40-60° C., for example, 40° C., 42° C., 45° C., 48° C., 50° C., 52° C., 55° C., 58° C., 60° C., etc.

In some preferred embodiments, the residence time of the PVA-based film in the stretching tank is 1-10 min, preferably 1 min, 2 min, 3 min, 5 min, 6 min, 8 min, 10 min, etc.

In some preferred embodiments, the solvent used in the stretching solution includes not only water but also preferably an alcohol-based solvent, more preferably, ethanol solvent, thereby achieving better dissolution of organic boron.

In some preferred embodiments, the preparation method further includes carrying out color complementation and drying after stretching.

In some preferred embodiments, the method for preparing a polarizing film preferably includes PVA unwinding, swelling, dyeing, washing (crosslinking), stretching, color compensation, and drying sequentially. Optionally, washing performed before swelling may also be included. The specific steps are as follows:

Washing: The PVA-based film is placed in a washing tank, and the plasticizer in the PVA-based film is removed through washing.

Color compensation: The stretched PVA-based film is immersed in a color compensation tank for color compensation.

Dyeing: The color-compensated PVA-based film is subjected to water cutting and then dried to obtain a polarizing film.

In the present disclosure, for PVA unwinding, during the preparation process, the PVA-based film is conveyed continuously and stably through an unwinding device to proceed to subsequent processes. The present disclosure does not impose limitations on the unwinding device or the unwinding method, and any unwinding device and unwinding method capable of achieving the purpose of continuous and stable conveyance in the present disclosure may be applied herein. Only exemplary listings are provided here: the unwinding device may include a single-station unwinder, a dual-station unwinder or an optical-grade unwinder, and the unwinding method may include active unwinding or passive unwinding, without excessive limitations herein.

In the present disclosure, no excessive limitations are imposed on color compensation and drying, and any method capable of achieving the aforementioned steps may be applied to the present disclosure. The present disclosure only provides exemplary listings here.

For color compensation, uneven polarizing performance caused by uneven solution distribution, variations in film thickness or mechanical damage during the dyeing process can be corrected by locally supplementing the adsorption of iodine molecules, thereby ensuring that the final polarizing film meets standards in terms of polarization degree, transmittance, and optical consistency.

The color compensation may be carried out in a color compensation tank. The time of immersing in the color compensation solution is preferably 10-30 s, for example, 10 s, 15 s, 20 s, 25 s, 30 s, etc. Preferably, the color compensation solution is the same as the dyeing solution or has a slightly higher concentration to enhance the compensation effect.

The purpose of drying is to remove residual moisture from the surface and interior of the film, solidify the crosslinked structure between PVA molecular chains, and stabilize the adsorption state of iodine molecules, thereby obtaining a polarizing film with excellent polarizing performance, mechanical strength, and durability. Typically, drying is divided into 3-5 temperature zones, including: an inlet zone, generally at 60-80° C., for example, 60° C., 65° C., 70° C., 75° C., 80° C., etc.; a middle zone, generally at 80-100° C., for example, 80° C., 85° C., 90° C., 95° C., 100° C., etc.; and an outlet zone, generally at 100-120° C., for example, 100° C., 105° C., 110° C., 115° C., 120° C., etc. The time of dyeing is typically 2-10 min, for example, 2 min, 3 min, 4 min, 5 min, 6 min, 7 min, 8 min, 9 min, 10 min, etc., preferably, 3-5 min. The present disclosure will not elaborate further on this herein.

A second object of the present disclosure is to provide a polarizing film prepared by the preparation method described in the first object.

A third object of the present disclosure is to provide a polarizer. The polarizer includes the polarizing film described in the second object.

In some preferred embodiments, the polarizer further includes a first protective layer, a second protective layer, a pressure-sensitive adhesive layer, and a release film layer.

The first protective layer and the second protective layer are located on both sides of the polarizing film, respectively, the pressure-sensitive adhesive layer is located on a side of any protective layer facing away from the polarizing film, and the release film layer is located on a side of the pressure-sensitive adhesive layer facing away from the polarizing film.

In some preferred embodiments, as shown in FIG. 4, the polarizer includes a first protective layer 1, a polarizing film 2, a second protective layer 3, a first pressure-sensitive adhesive layer 4, and a release film layer 5 sequentially arranged.

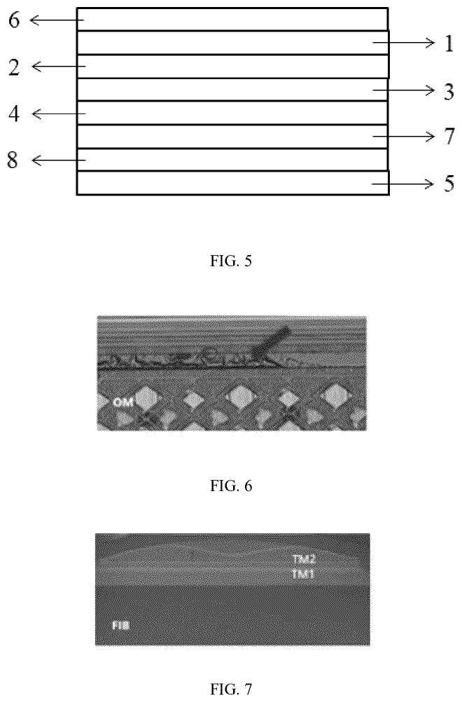

In some preferred embodiments, as shown in FIG. 5, the polarizer includes a hard coating layer 6, a first protective layer 1, a polarizing film 2, a second protective layer 3, a first pressure-sensitive adhesive layer 4, a phase difference film 7, a second pressure-sensitive adhesive layer 8, and a release film layer 5 sequentially arranged.

The present disclosure may further provide a method for preparing a polarizer. The method for preparing a polarizer includes the following steps.

After the polarizing film is prepared, the polarizing film is laminated with protective layers on both sides, dried, combined with a release film, and wound. In some preferred embodiments, the protective film may be a triacetate cellulose (TAC) film, and the release film may be a polyethylene (PE) film or a polyethylene terephthalate (PET) film.

The following examples are provided for further illustration.

### Preparation Example 1

This preparation example provides a method for preparing a polarizing film. The preparation method is as follows:

(1) Washing: A PVA-based film was placed in a washing tank for washing.

(2) Swelling: The cleaned PVA-based film was placed in a swelling tank containing organic aromatic boric acid for swelling treatment, and the swelling treatment was carried out at a temperature of 50° C. for 3 min.

The organic aromatic boric acid was

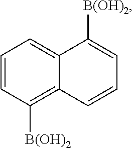 [SMILES: OB(O)c1cccc2c(B(O)O)cccc12]

at a concentration of 5%, in which the solvent was deionized water, and 10% ethanol was added.

(3) Dyeing: The swollen PVA-based film was immersed in a dyeing tank containing a dyeing solution to dye, where the concentration of iodine in the dyeing solution was 0.01 mol/L, the concentration of potassium iodide was 0.1 mol/L, and the dyeing was carried out at a temperature of 50° C. for 1 min.

(4) Washing (Crosslinking): After dyeing was completed, the PVA-based film was washed in a cleaning tank containing deionized water.

(5) Stretching: The washed PVA-based film was placed in a stretching tank for stretching, where the stretching tank contained 5% boric acid, and the stretching was carried out at a temperature of 50° C. for 4 min, with a stretching ratio of 5 times.

(6) Color Compensation: Color compensation was carried out using a dyeing solution for 20 s.

(7) Dyeing: After color compensation was completed, drying was carried out with the inlet zone at 70° C., the middle zone at 90° C., and the outlet zone at 110° C., for 4 min.

(8) Winding: The film was wound to obtain a polarizing film.

### Preparation Examples 2 to 7

These preparation examples provide a method for preparing a polarizing film.

The difference from Preparation Example 1 is that, in these preparation examples, the organic aromatic boric acid used was:

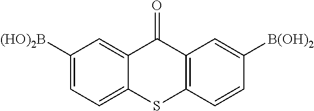 [SMILES: O=c1c2cc(B(O)O)ccc2sc2ccc(B(O)O)cc12]

### (Preparation Example 2),

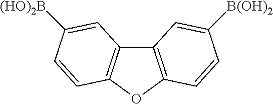 [SMILES: OB(O)c1ccc2oc3ccc(B(O)O)cc3c2c1]

### (Preparation Example 3),

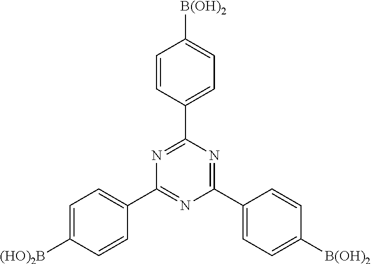 [SMILES: OB(O)c1ccc(-c2nc(-c3ccc(B(O)O)cc3)nc(-c3ccc(B(O)O)cc3)n2)cc1]

### (Preparation Example 4),

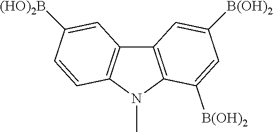 [SMILES: Cn1c2ccc(B(O)O)cc2c2cc(B(O)O)cc(B(O)O)c21]

### (Preparation Example 5),

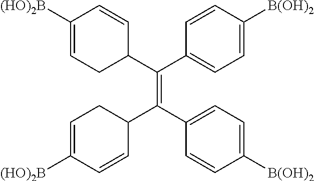 [SMILES: OB(O)C1=CCC(/C(=C(/c2ccc(B(O)O)cc2)C2C=CC(B(O)O)=CC2)c2ccc(B(O)O)cc2)C=C1]

### (Preparation Example 6), and

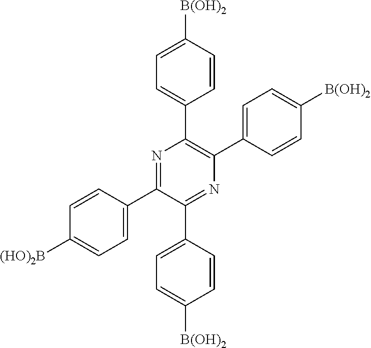 [SMILES: OB(O)c1ccc(-c2nc(-c3ccc(B(O)O)cc3)c(-c3ccc(B(O)O)cc3)nc2-c2ccc(B(O)O)cc2)cc1]

### (Preparation Example 7).

### Preparation Examples 8 to 9

These preparation examples provide a method for preparing a polarizing film.

The difference from Preparation Example 1 is that in these preparation examples, the concentration of organic aromatic boric acid used was 2% (Preparation Example 8) and 8% (Preparation Example 9).

### Comparative Preparation Example 1

This comparative preparation example provides a method for preparing a polarizing film.

The difference from Preparation Example 1 is that, in this comparative preparation example, the organic aromatic boric acid was replaced with boric acid, with the concentration unchanged.

### Examples 1 to 9

These examples provide a method for preparing a polarizer. The preparation method is as follows:

On one side of the polarizing films provided in Preparation Examples 1 to 9, a TAC film (purchased from Fujifilm Corporation, Japan) having a thickness of 25 μm was laminated, and on the other side, a TAC film (purchased from Fujifilm Corporation, Japan) having a thickness of 25 μm, an optical compensation layer (purchased from Fujifilm Corporation, Japan), a pressure-sensitive adhesive (purchased from Soken) having a thickness of 20 μm, and a release film (purchased from Mitsubishi Chemical Corporation, Japan) having a thickness of 50 μm were laminated sequentially to obtain polarizers.

### Comparative Example 1

This comparative example provides a method for preparing a polarizer.

The difference from Example 1 is that, in this comparative example, the polarizing film used was the polarizing film prepared in Comparative Preparation Example 1.

### Performance Test

Performance tests were conducted on samples provided by Examples and Comparative Examples as follows:

### (1) Reliability Test:

i. Devices were prepared by laminating in order from bottom to top: an SCF layer (purchased from Dwell, 160 μm), a BP layer (purchased from Nitto Denko Corporation, 88 μm), a display panel, the polarizer, an OCA layer (purchased from 3M), and a lens layer (purchased from AGC). The prepared devices were placed at 85° C. and 85% relative humidity (RH) for 240 h to observe whether corrosion occurred around the module and on the TP traces in the hole area.

FIG. 6 is an OM image of the device prepared in Comparative Example 1, observed using an ultra-depth-of-field microscope (Keyence VHX-700) at a magnification of 100 times. It can be seen from the figure that the device of Comparative Example 1 was corroded. FIB analysis (instrument: Thermo Scientific Helios 400) was performed on the corrosion points, and the results are shown in FIG. 7. FIG. 7 is an image of an FIB section of a moiety in which the device prepared in Comparative Example 1 underwent corrosion. As can be seen from FIG. 7, the aluminum (Al) layer in the Ti/Al/Ti among film layers was corroded.

In contrast, devices prepared in Examples 1 to 9 showed no corrosion.

ii. An Al film having a thickness of 300 nm was deposited on a glass substrate by PVD process, then the release film of the polarizer was removed, and the side of the pressure-sensitive adhesive layer was laminated onto the Al film. Tests were conducted under HAST conditions (110° C., 85% RH, 24 h), dual 85 conditions (85° C., 85% RH) for 480 h, and 65° C./95% RH conditions for 480 h to check if the Al film was corroded.

The devices provided by Examples 1 to 9 showed no corrosion, while the device provided by Comparative Example 1, which used boric acid for swelling treatment, showed severe corrosion, indicating that the polarizer provided by the present disclosure can inhibit polyene reactions and improve the stability of the polarizing film.

iii. Devices were prepared according to i. The prepared devices were tested under HAST conditions (110° C., 85% RH, 24 h), dual 85 conditions for 480 h, and 65° C./95% RH conditions for 480 h to check for corrosion around the module and on the TP traces in the hole area. The test results are as follows:

The devices provided by Examples 1 to 9 showed no corrosion, while the device provided by Comparative Example 1, which used boric acid for swelling treatment, showed severe corrosion, indicating that the polarizer provided by the present disclosure can inhibit polyene reactions and improve the stability of the polarizing film.

(2) Absorption Spectrum Test: The transmittance curves of the polarizing films provided by Example 1 and Comparative Example 1 were tested using a UV-Vis absorption spectrometer.

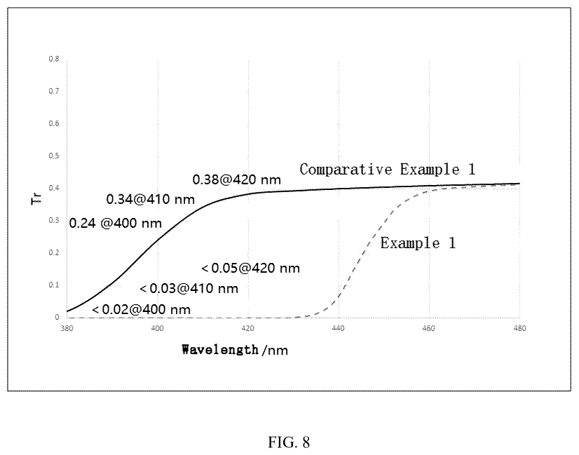

FIG. 8 is a comparison diagram of transmittance curves of the polarizers provided by Example 1 and Comparative Example 1. As shown in the figure, the transmittance values of the polarizer provided by Comparative Example 1 at 400 nm, 410 nm, and 420 nm are 0.24, 0.34, and 0.38, respectively, while the transmittance values of the polarizer provided by Example 1 at 400 nm, 410 nm, and 420 nm are less than 0.02, 0.03, and 0.05, respectively, indicating that the polarizer provided by the present disclosure has an ultraviolet blocking capability.

(3) Water Resistance Performance: The water vapor transmission rates of the polarizers provided by Examples 1 to 9 and Comparative Example 1 were tested according to the GB/T 21529-2008 standard. The water vapor transmission rates were used to characterize the water resistance performance of the polarizing films.

The water vapor transmission rates of the polarizers provided by Examples 1 to 9 of the present disclosure were in the range of 50-70 g/m²·24 h, while the water vapor transmission rate of the polarizer provided by Comparative Example 1 was in the range of 80-100 g/m²·24 h. The comparison of these data indicates that the polarizer provided by the present disclosure exhibits certain water resistance performance.

The applicant has stated that although the process methods of the present disclosure are described through the preceding embodiments, the present disclosure is not limited to the preceding process steps, which means that the implementation of the present disclosure does not necessarily depend on the preceding process steps. It is to be understood by those skilled in the art that any improvements made to the present disclosure and equivalent replacements of raw materials adopted, additions of adjuvant ingredients, selections of specific manners, etc. in the present disclosure all fall within the scope of protection and disclosure of the present disclosure.

What is claimed is:

1. A method for preparing a polarizing film, comprising: subjecting a polyvinyl alcohol-based film to swelling, dyeing, crosslinking, and stretching, wherein a solution used in at least one of steps of swelling, dyeing, crosslinking or stretching comprises an organic aromatic boric acid.

2. The preparation method according to claim 1, wherein in the preparation method, a swelling solution used for swelling comprises an organic aromatic boric acid.

3. The preparation method according to claim 1, wherein a concentration of the organic aromatic boric acid in the swelling solution is 2-8 wt %.

4. The preparation method according to claim 1, wherein a functionality of the organic aromatic boric acid is greater than or equal to 2.

5. The preparation method according to claim 4, wherein the organic aromatic boric acid is selected from at least one of the following compounds:

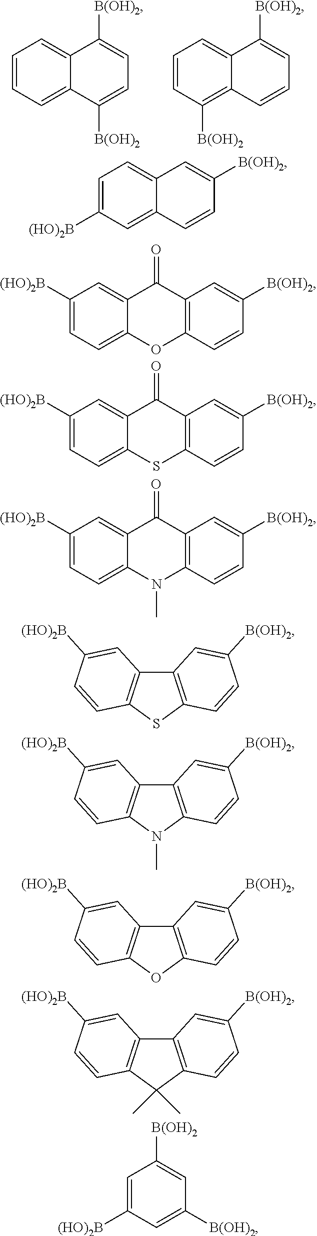

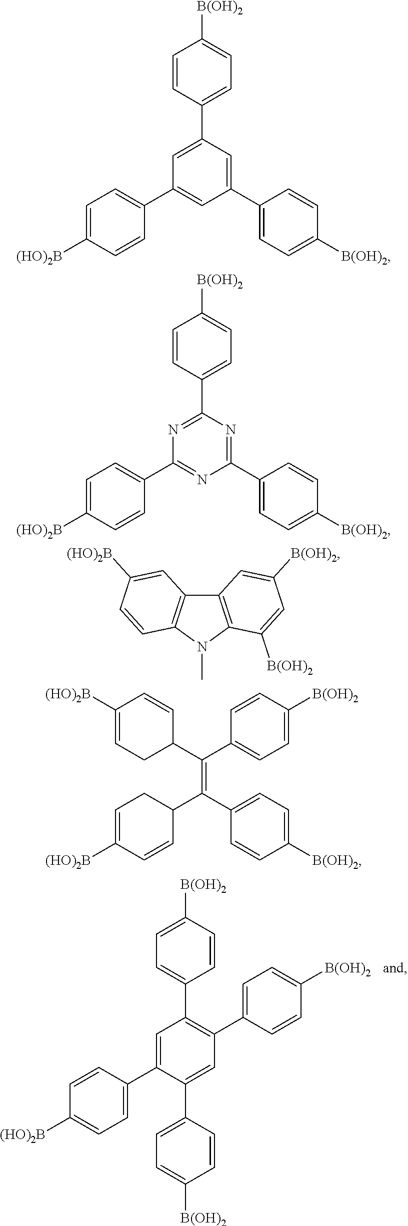

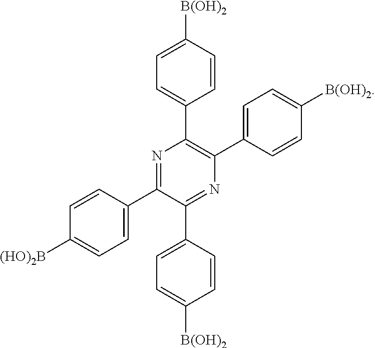 [SMILES: OB(O)c1ccc(-c2nc(-c3ccc(B(O)O)cc3)c(-c3ccc(B(O)O)cc3)nc2-c2ccc(B(O)O)cc2)cc1]

6. The preparation method according to claim 1, wherein the swelling is carried out at a temperature of 40-80° C. for 1-5 minutes (min).

7. The preparation method according to claim 1, further comprising: carrying out color complementation and drying after the stretching.

8. A polarizing film prepared by the preparation method according to claim 1.

9. A polarizer, comprising the polarizing film according to claim 8.

10. The polarizer according to claim 9, further comprising a first protective layer, a second protective layer, a pressure-sensitive adhesive layer, and a release film layer, wherein:
the first protective layer and the second protective layer are located on both sides of the polarizing film, respectively, the pressure-sensitive adhesive layer is located on a side of any protective layer facing away from the polarizing film, and the release film layer is located on a side of the pressure-sensitive adhesive layer facing away from the polarizing film.
